(19) United States
(12) Patent Application Publication
(10) Pub. No.: US 2011/0256307 A1
(43) Pub. Date: Oct. 20, 2011

(54) METHOD FOR MANUFACTURING CAPACITIVE TOUCH SCREEN

(76) Inventors: Sang Hwa KIM, Gyunggi-do (KR); Jong Young Lee, Gyunggi-do (KR)

(21) Appl. No.: 12/823,867

(22) Filed: Jun. 25, 2010

(30) Foreign Application Priority Data
Apr. 15, 2010 (KR) 10-2010-0034838

(51) Int. Cl. B05D 5/12

(52) U.S. Cl. 427/79

(57) ABSTRACT

Disclosed herein is a method for manufacturing a capacitive touch screen. The method for manufacturing the capacitive touch screen includes forming a plurality of first electrode patterns made of conductive polymer on the upper surface of a first substrate by an inkjet method, thereby making it possible to finely and precisely form the electrode patterns having a complex shape.

Further, the present invention can make a process for manufacturing a capacitive touch screen simple and spray only the necessary amount of conductive polymer at an accurate position, such that waste materials can be prevented and the thickness of the electrode pattern is easily controlled to form the electrode pattern having a uniform thickness.

### CROSS REFERENCE TO RELATED APPLICATION

This application claims the benefit of Korean Patent Application No. 10-2010-0034838, filed on Apr. 15, 2010, entitled “Method For Manufacturing Capacitive Touch Screen”, which is hereby incorporated by reference in its entirety into this application.

### BACKGROUND OF THE INVENTION

1. Technical Field

The present invention relates to a method for manufacturing a capacitive touch screen.

2. Description of the Related Art

With the development of mobile communication technology, user terminals such cellular phones, PDAs, navigations can serve as a display unit that simply displays character information as well as a unit for providing various and complex multi-media such as audio, moving picture, radio internet web browser, etc. Therefore, electronic information terminals having a limited size require a larger display screen, such that a display using a touch screen type has become the main focus.

The touch screen has an advantage of saving space by integrating a screen and a coordinate input unit, as compared to a key input type according to a prior art. Therefore, recently developed display apparatuses using the display with the touch screen have increased in use in consideration of the screen size and the user convenience.

A type of touch screen mainly used is largely classified into two types.

The first type is a resistive touch screen when upper/lower electrode layers are spaced from each other by a spacer and are disposed to contact each other by pressing. When the upper substrate on which the upper electrode layer is formed is pressed by input units such as fingers, pen, and so on, the upper/lower electrode layers generate conduction and the contact coordinates are recognized due to the change in voltage according to the change in resistance value in the controller.

The second type is the capacitive touch screen, where the upper substrate on which the first electrode pattern is formed and the lower substrate on which the second electrode pattern is formed are spaced from each other and the insulator is inserted therebetween to prevent the first electrode pattern from contacting the second electrode pattern.

Generally, the electrode patterns formed on the upper substrate and the lower substrate of the capacitive touch screen are made of ITO and are formed in plural and have a complex shape, including a sensing unit and a connection unit. In order to form the electrode patterns having the to above complicated shape, an ITO electrode layer is formed and then the patterning is performed, and this patterning process is performed by a laser method, a photolithography method.

Meanwhile, in forming the capacitive touch, a demand to apply conductive polymer with excellent flexibility, film adhesion and thermal expansion instead of applying ITO to the electrode pattern has increased. The reason is that the touch screens are being considered in new fields such as a flexible display field and fields emphasizing durability.

When the electrode patterns made of conductive polymer is formed on the capacitive touch screen, there are several problems in forming the electrode patterns according to a manufacturing method of a prior art.

When the electrode layer is formed and the patterning is performed by a dry process such as a laser method, there are problems in that the electrode patterns are non-uniform due to the damage to the remaining electrode patterns and the characteristics of the electrode patterns are changed due to high-temperature conduction.

In a wet process such as a photolithography method, when patterning is performed using an etching solution of a prior art, the electrode patterns are non-uniform. Therefore, a need exists for the development of new etching solutions. Further, the wet process (execution of exposing, developing, etching, peeling, cleaning, and drying steps) is complicated and causes secondary problems such as environmental pollution due to the use of organic solvents.

### SUMMARY OF THE INVENTION

The present invention has been made in an effort to provide a method for manufacturing a capacitive touch screen capable of implementing conductive polymer electrode patterns, uniformity and productivity of the electrode patterns by forming the electrode patterns using conductive polymer materials, and forming the electrode patterns on a substrate by an inkjet method.

A method for manufacturing a capacitive touch screen according to a preferred embodiment of the present invention includes: forming a plurality of first electrode patterns made of conductive polymer on the upper surface of a first substrate by an inkjet method; forming an insulating layer on the first electrode pattern; forming a plurality of second electrode pattern made of conductive polymer on the insulating layer by an inkjet method; and forming a second substrate on the insulating layer on which the second electrode pattern is formed.

The method for manufacturing the capacitive touch screen further includes forming first electrode wirings made of metal and connected to the first electrode patterns at the edge regions of the first substrate, prior to the forming the first electrode patterns.

The method for manufacturing the capacitive touch screen further includes surface-reforming the first electrode pattern forming region on the upper surface of the first substrate, prior to forming the first electrode pattern.

The method for manufacturing the capacitive touch screen further includes forming second electrode wirings made of metal and connected to the second electrode patterns at the edge regions of the insulating layer therebetween while forming the insulating layer and the forming the second electrode pattern.

At the forming the first electrode pattern, the conductive polymer forming the first electrode patterns may be any one of polythiophene, polypyrrole, polyaniline, polyacetylene, and polypheylene polymers.

At the forming the first electrode pattern, the conductive polymer includes an alcohol solvent and the viscosity of the conductive polymer is 5 cps to 20 cps.

At the forming the first electrode pattern, the conductive polymer may include silane-based compounds.

A method for manufacturing a capacitive touch screen according to a preferred embodiment of the present invention includes: forming a plurality of first electrode patterns made of conductive polymer on the upper surface of a first substrate by an inkjet method; forming a plurality of second electrode patterns made of conductive polymer on the upper surface of a second substrate by the inkjet method; and coupling the first substrate and the second substrate so that the first electrode patterns face the second electrode pattern, with an insulating layer therebetween.

The method for manufacturing the capacitive touch screen further includes forming first electrode wirings made of metal and connected to the first electrode patterns at the edge regions of the first substrate, prior to forming the first electrode patterns on the first substrate, and forming second electrode wirings made of metal and connected to the second electrode patterns at the edge regions of the second substrate, prior to forming the second electrode patterns on the second substrate.

The method for manufacturing the capacitive touch screen further includes surface-reforming the first electrode pattern forming region on the upper surface of the first substrate, prior to forming the first electrode pattern, and surface-reforming the second electrode pattern forming region on the upper surface of the second substrate, prior to forming the second electrode pattern.

At the forming the first electrode pattern and the forming the second electrode pattern, the conductive polymer forming the first electrode pattern and the second electrode pattern may be any one of polythiophene, polypyrrole, polyaniline, polyacetylene, and polypheylene polymers.

At the forming the first electrode pattern and the forming the second electrode pattern, the conductive polymer includes an alcohol solvent and the viscosity of the conductive polymer is 5 cps to 20 cps.

At the forming the first electrode patterns, the conductive polymer may include silane-based compounds.

### BRIEF DESCRIPTION OF THE DRAWINGS

FIG. 1 is an exploded perspective view of a capacitive touch screen manufactured according to a preferred embodiment of the present invention.

FIGS. 2 to 9 are plan views and cross-sectional views sequentially showing a method for manufacturing a capacitive touch screen according to a first embodiment of the present invention.

FIGS. 10 to 15 are plan views and cross-sectional views sequentially showing a method for manufacturing a capacitive touch screen according to a second embodiment of the present invention.

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the tem to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, in describing the present invention, a detailed description of related known functions or configurations will be omitted so as not to obscure the subject of the present invention.

Hereinafter, preferred embodiments of the present invention will be described in detail with reference to the accompanying drawings.

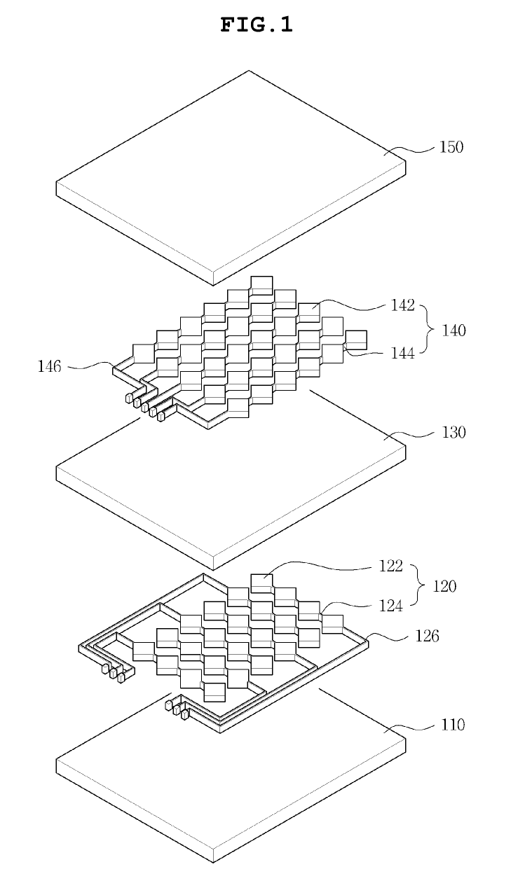

FIG. 1 is an exploded perspective view of a capacitive touch screen manufactured according to a preferred embodiment of the present invention. Hereinafter, a capacitive touch screen to which a manufacturing method of the present invention can be applied will be described with reference to FIG. 1.

A capacitive touch screen 100 includes a plurality of first electrode patterns 120 (X-direction electrode patterns) formed on a first substrate 110.

As the first substrate 110, a glass substrate, a film substrate, a fiber substrate, a paper substrate, and so on, which are a transparent member, may be used. Among those, the film substrate may be made of polyethyleneterephthalate (PET), polymethylmetacrylate (PMMA), polypropylene (PP), polyethylene (PE), polyethylenenaphthalenalicarboxylate (PEN), polycarbonate (PC), polyethersulfone (PES), polyimide (PI), polyvinylalcohol (PVA), cyclic olefin copolymer (COC), styrene polymer, polyethylene, polypropylene, etc., but are not particularly limited thereto.

At this time, the first electrode pattern 120 is made of a conductive polymer. The conductive polymer may use polythiophene, polypyrrole, polyaniline, polyacetylene, polypheylene as organic compounds, etc. In particular, PEDOT/PSS compound among the polythiophene-based organic compounds is most preferable and one or more mixture among the organic-based compounds may be used. Further, when carbon nanotube, etc., is further added to the organic compounds, conductivity may be further increased.

The plurality of electrode patterns 120 formed on the first substrate 110 are formed in parallel in a first direction (X direction) and is configured to include first sensing units 122 and a first connection unit 124. The first sensing units 122 sense the change in capacitance when a user's hand touches the touch screen and the first connection unit 124 connects the plurality of first sensing units 122.

Meanwhile, although the first sensing unit 122 having a diamond shape is shown in FIG. 1, it is shown by way of example only and therefore, may have other shapes.

First electrode wirings 126 connected to the first electrode patterns 120 are formed on the first substrate 110. The first electrode wiring 126 is made of metal (for example, silver (Ag)) and extends to the edge regions of the first substrate 110, such that the distal ends of the first electrode wirings 126 are disposed to be collected at the edges of the first substrate 110. The edge regions at which the distal ends of the first electrode wirings 126 are collected are called a connection unit. The connection unit is connected to an FPCB (not shown) and transfers the change in capacitance of the first electrode pattern 120 to a controller (not shown).

An insulating layer 130 is formed on the first electrode patterns 120. The insulating layer 130 separates the first electrode patterns 120 from second patterns 140 to be described below to prevent the first electrode patterns 120 from contacting the second electrode patterns 140. The insulating layer 130 may be made of transparent insulating materials, but kinds of insulting materials are not limited.

Further, the plurality of second electrode patterns 140 are formed on the insulating layer 130 and are formed in parallel in a second direction (Y direction). The second pattern 140 is made of the same material as the first electrode pattern 120 and has the same structure as the first electrode pattern 120.

However, second sensing units 142 of the second electrode patterns 140 are formed to be disposed in a space in which the plurality of adjacent first sensing units 122 of the first electrode patterns 120 are formed to prevent the centers of the second sensing units 142 of the second electrode patterns 140 from completely overlapping with the centers of the first sensing units 122 of the first electrode patterns 120.

Further, a plurality of second electrode wirings 146 are formed on the insulating layer 130. The second electrode wiring may also be made of the same material as the first electrode wiring 126 and the distal end thereof extends to be disposed at the connection unit formed on the insulating layer 130.

A second substrate 150 is formed on the insulating layer 130 on which the second electrode pattern 140 is formed. The second substrate 150 may also be made of the same material as the first substrate 110. The second substrate 150 forms a touch surface on which the user's fingers touch and serves as a protective layer that protects the second electrode pattern 140 and the second electrode wiring 146.

Meanwhile, when the insulating layer 130 is stacked on the first electrode pattern 120 and the first electrode wiring 126 and the second substrate 150 is stacked on the insulating layer 130, optical adhesives such as OCA may be used.

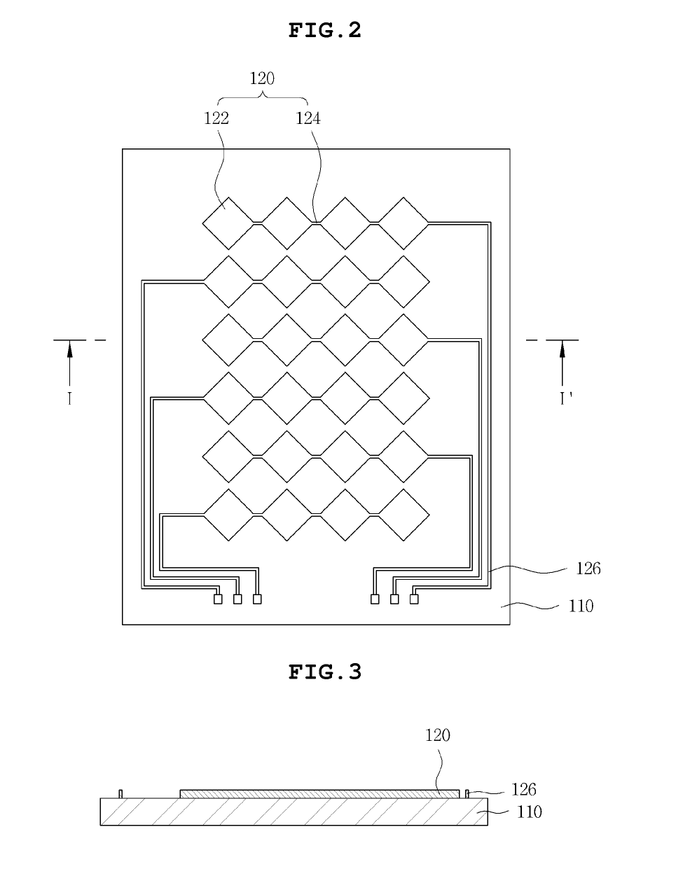

FIGS. 2 to 9 are plan views and cross-sectional views sequentially showing a method for manufacturing a capacitive touch screen according to a first embodiment of the present invention. Hereinafter, a method for manufacturing a capacitive touch screen according to the present invention will be described with reference to FIGS. 2 to 9.

As shown in FIGS. 2 and 3, the plurality of first electrode patterns 120 made of conductive polymer are first formed on the upper surface of the first substrate 110 by an inkjet method.

The conductive polymer ink is filled in an inkjet apparatus, which is in turn printed on the first substrate 110 to have the above-mentioned shape. Even though its shape is complicated, the first electrode pattern 120 is configured to include the first sensing unit 122 and the first connection unit 124 as described above. However, when the electrode pattern is formed by a laser method or a photolithography method in a prior art, the reliability of the electrode pattern is degraded.

When the first electrode pattern 120 made of conductive polymer is formed by the inkjet method, sheet resistance can be easily changed by controlling the line width and thickness of the electrode pattern.

The sheet resistance of the first electrode pattern 120 made of the conductive polymer printed by the inkjet method is preferably 100Ω/□ to 1000Ω/□, more preferably, 100Ω/□ to 250Ω/□. The range of the sheet resistance can be achieved by changing the thickness of the electrode pattern by controlling the printing frequency.

Further, it is preferable to surface-reform the area (first electrode pattern forming region) in which the electrode pattern will be formed on the upper surface of the first substrate 110 before printing the electrode pattern. Therefore, the adhesion between the first substrate 110 and the first electrode pattern 120 is improved.

When the glass substrate is used, the surface reforming is performed by the UV and ozone treatment. Surface reforming increases the surface energy so as to minimize a contact angle between the conductive polymer ink and the substrate. It is preferable that the UV and ozone treatment time is about 1 to 10 minutes. However, when the line width of the electrode pattern requires a fine pattern less than 50 μm, there is a need to minimize the treatment time and lower the surface energy.

Meanwhile, in case of the film substrate, the adhesion between the conductive polymer ink and the substrate can be improved by performing surface reforming using plasma, ion beam, corona discharge treatments, etc.

When the first electrode pattern 120 is printed on the upper surface of the first substrate 110 by the inkjet method, the conductive polymer (conductive polymer ink) includes one or more solvent to control its viscosity. For example, polar solvents such as water, alcohol, and so on, may be used. For example, methyl alcohol, ethyl alcohol, propyl alcohol, isopropyl alcohol, n-butyl alcohol, dimethyl formamide, dimethyl sulfoxide, dimethyl acetamide, acetone, diacetyl alcohol, glycyl alcohol, dioxane, ethylene glycol, propylene glycol, butylene glycol, diethylene glycol, and so on, may be used.

In particular, the conductive polymer includes an alcohol solvent and its viscosity is preferably 5 cps to 20 cps.

Further, in order to improve the adhesion between the first substrate 110 and the first electrode pattern 120 made of the conductive polymer, it is preferable that the conductive polymer printed by the inkjet apparatus further includes silane-based compounds. Among the silane-based compounds, alkoxy silane-based compound sharing organic and inorganic-based characteristics is particularly preferable. The alkoxy silane-based compound may include γ-glycidoxypropyltrimethoxysilane, vinyltrimethoxysilane, γ-chloropropyltrimethoxysilane, N-β aminoethyl, γ-aminopropyltrimethoxysilane, γ-mercaptopropyltrimethoxysilane, and so on, which serve as a coupling agent. Among those, the γ-glycidoxypropyltrimethoxysilane is more preferable.

The first electrode wiring 126 connected to the first electrode pattern 120 is formed on the first substrate 110. Since the first electrode wiring 126 is generally made of an opaque conductive material, it is formed at the edge region of the first substrate 110. Further, the first electrode wiring 126 may be previously formed on the first substrate 110 before the first electrode pattern 120 is formed.

At this time, when the first electrode wiring 126 is made of metal such as silver (Ag), it is preferable that the first electrode wiring 126 is formed on the first substrate 110 followed by the first electrode pattern 120. In order to form the electrode wiring using metal such as silver (Ag), the photolithography process is used. Since this process is performed at higher temperature than a process printing the conductive polymer, the electrode pattern may be damaged when the electrode pattern made of conductive polymer is previously printed. Therefore, the problem can be solved by forming the first electrode wiring 126 made of metal and then forming the first electrode pattern 120 to be connected to the first electrode wiring 126 by the inkjet method.

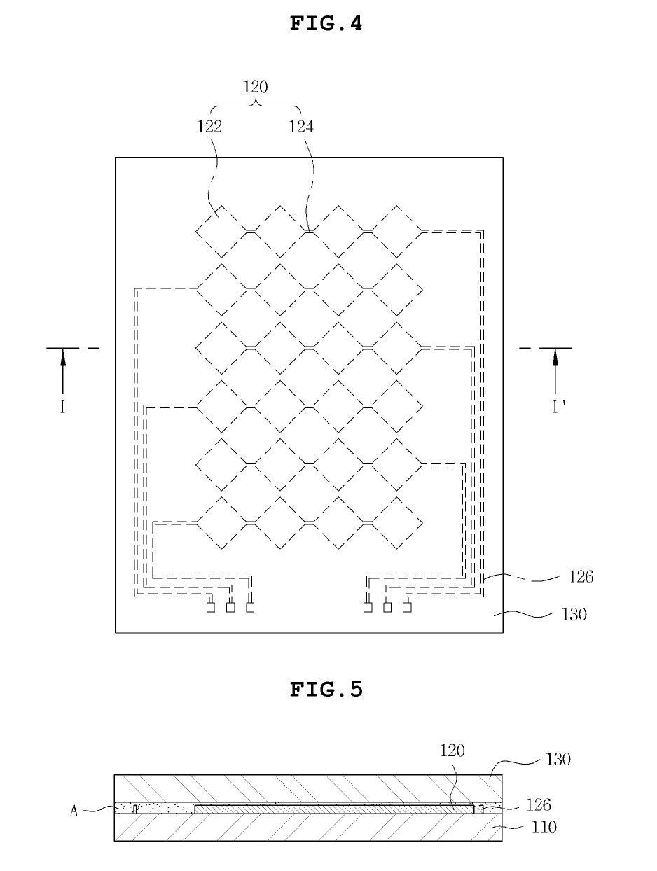

Next, referring to FIGS. 4 and 5, the insulating layer 130 is formed on the first substrate 110 on which the first electrode patterns 120 are formed. The insulating layer 130 is formed to completely cover the first substrate 110 such that the first electrode patterns 120 do not contact the second electrode patterns 140 to be described below.

When the insulating layer 130 is made of the glass substrate, it may be stacked with an optical adhesive A. In addition, when the insulating layer is made of transparent plastic resin, it may be formed by being applied to the first substrate 110 using the inkjet method and when the insulating layer is made of the film substrate, it may be formed by a laminating method and with the optical adhesive having a predetermined thickness.

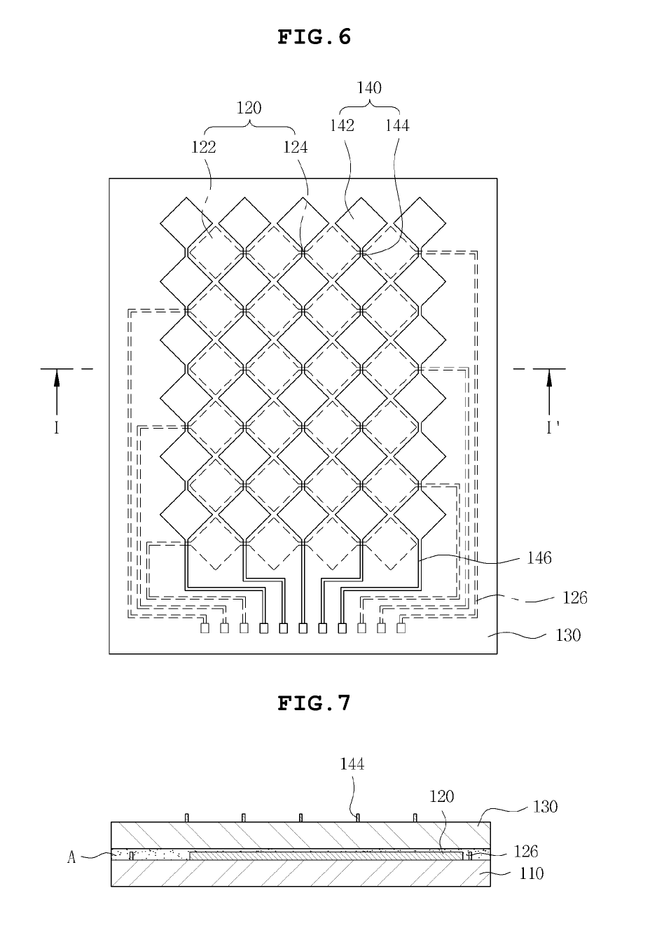

Thereafter, as shown in FIGS. 6 and 7, the plurality of second electrode patterns 140 made of the conductive polymer is formed on the insulating layer 130 by the inkjet method as shown in FIGS. 6 and 7. A method for forming the second electrode pattern 140 on the insulating layer 130 may be performed by the same process as the method for forming the first electrode pattern 120 on the first substrate 110 and the detailed description thereof will be omitted.

In addition, the second electrode wiring 146 formed at the edge region of the insulating layer 130 may also be formed by the same method as the method for forming the first electrode wiring 126 formed on the first substrate 110. However, when the second electrode wiring is made of metal, it is preferable that the second electrode wiring is formed on the insulating layer 130 before the second electrode pattern 140 is formed on the insulating layer 130.

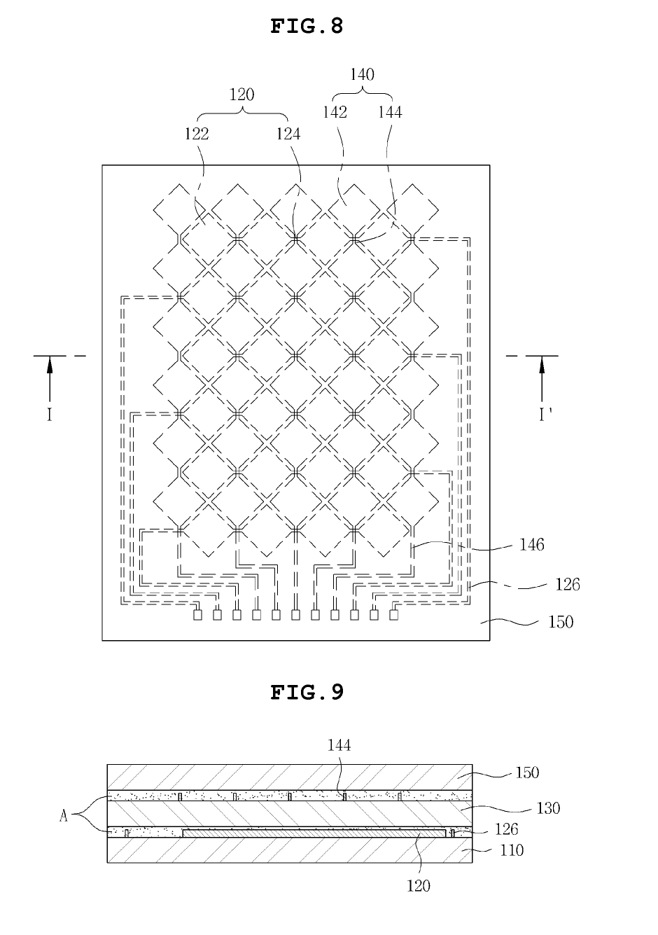

Next, referring to FIGS. 8 and 9, the second substrate 150 is formed on the insulating layer 130 on which the second electrode patterns 140 are formed. The second substrate 150 serves as the protective layer that protects the second electrode pattern 140 when pressed by the user's fingers. When the second substrate 150 is made of the glass substrate, it may be stacked with the optical adhesive A and when the second substrate 150 is made of the film substrate, it may be processed by the laminating method.

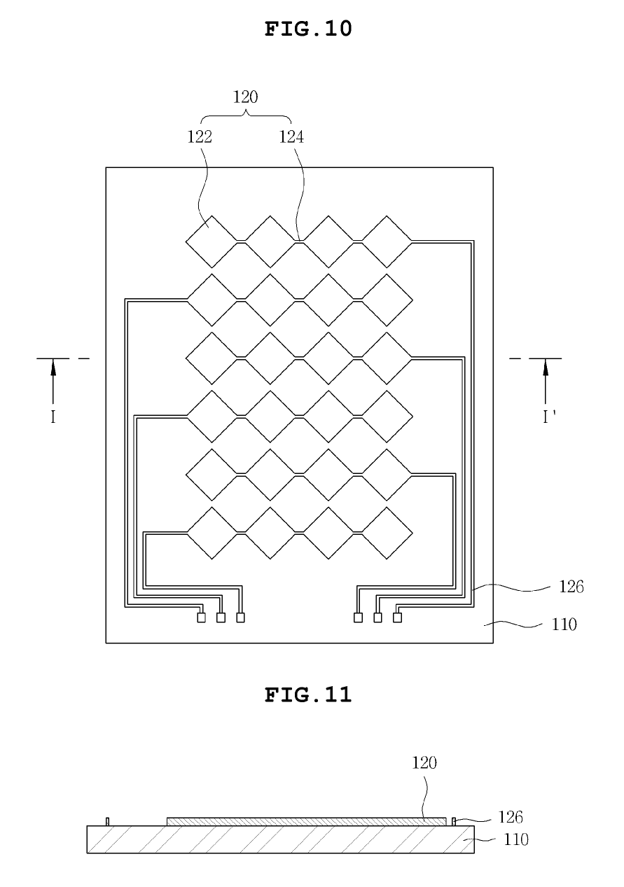

FIGS. 10 to 15 are plan views and cross-sectional views sequentially showing a method for manufacturing a capacitive touch screen according to a second embodiment of the present invention. Hereinafter, the method for manufacturing a capacitive touch screen according to the second embodiment of the present invention will be described with reference to FIGS. 10 to 15. However, the detailed description of the same configuration as the configuration described with reference to FIGS. 1 to 9 will be omitted.

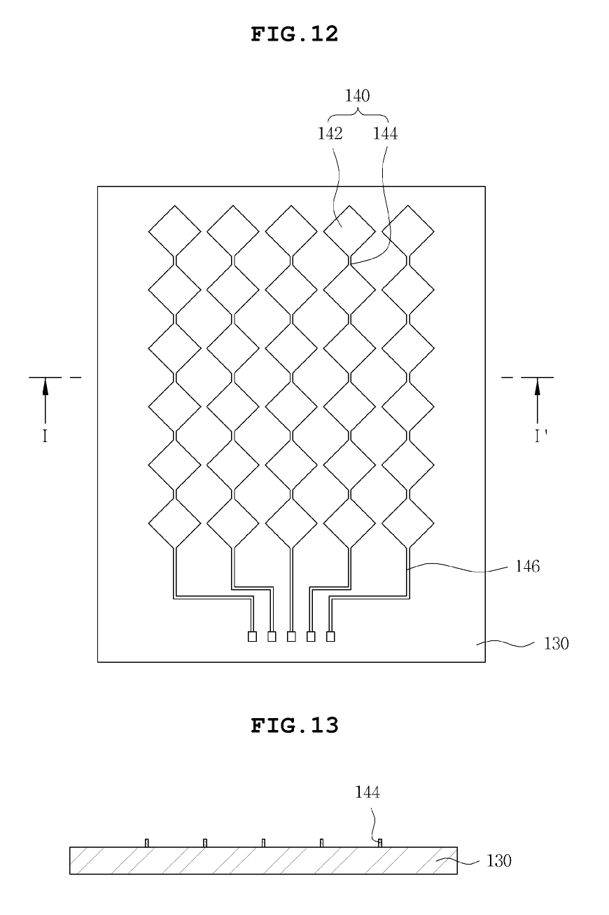

As shown in FIGS. 10 and 11, the plurality of first electrode patterns 120 made of a conductive polymer are formed on the upper surface of the first substrate 110 by the inkjet method and as shown in FIGS. 12 and 13, the plurality of second electrode patterns 140 made of the conductive polymer are formed on the upper surface of the second substrate 150 by the inkjet method. The method for forming the electrode patterns on the substrate is the same as the method described with reference to FIGS. 2 and 3.

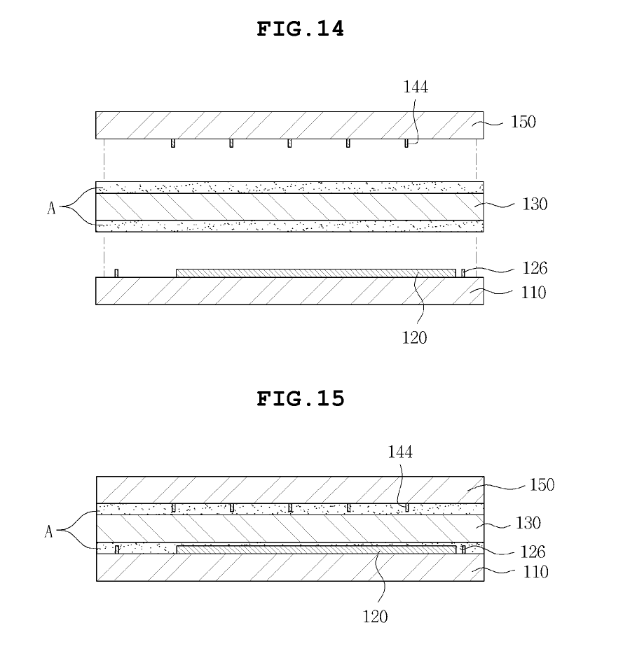

As shown in FIGS. 14 and 15, the first substrate 110 and the second substrate 150 are coupled with each other so that the first electrode patterns 120 faces the second electrode patterns 140, with the insulating layer 130 therebetween. When the insulating layer 130 is made of the glass substrate, it may be stacked with the optical adhesive A. In addition, when the insulating layer 130 is made of the film substrate, it may be stacked by the laminating method, that is, the transparent plastic resin is applied to the first substrate 110 by the inkjet method to cover the first electrode pattern and the second substrate 150 may be stacked on the first substrate 110.

According to the present invention, the method for manufacturing the capacitive touch screen forms the electrode patterns made of the conductive polymer by the inkjet method, thereby making it possible to finely form the electrode pattern having a complex shape.

Further, according to the present invention, the electrode pattern made of the conductive polymer is formed by the inkjet method to make the manufacturing process simple and print only the necessary amount of conductive polymer at an accurate position, thereby making it possible to prevent waste materials.

In addition, according to the present invention, the thickness of the electrode pattern is easily controlled, making it possible to form the electrode pattern having uniform thickness.

Although the embodiments of the present invention has been disclosed for illustrative purposes, those skilled in the art will appreciate that various modifications, additions and substitutions are possible, without departing from the scope and spirit of the invention. Accordingly, any and all modifications, variations or equivalent arrangements should be considered to be within the scope of the invention, and the detailed scope of the invention will be disclosed by the accompanying claims.

What is claimed is:

1. A method for manufacturing a capacitive touch screen, comprising:
forming a plurality of first electrode patterns made of conductive polymer on the upper surface of a first substrate by an inkjet method;
forming an insulating layer on the first electrode pattern;
forming a plurality of second electrode patterns made of conductive polymer on the insulating layer by the inkjet method; and
forming a second substrate on the insulating layer on which the second electrode pattern is formed.

2. The method for manufacturing the capacitive touch screen as set forth in claim 1, further comprising forming first electrode wirings made of metal and connected to the first electrode patterns at the edge regions of the first substrate, prior to the forming the first electrode patterns.

3. The method for manufacturing the capacitive touch screen as set forth in claim 1, further comprising surface-reforming the first electrode pattern forming region on the upper surface of the first substrate, prior to forming the first electrode pattern.

4. The method for manufacturing the capacitive touch screen as set forth in claim 1, further comprising forming second electrode wirings made of metal and connected to the second electrode patterns at the edge regions of the insulating layer between forming the insulating layer and forming the second electrode pattern.

5. The method for manufacturing the capacitive touch screen as set forth in claim 1, wherein at the forming the first electrode pattern, the conductive polymer forming the first electrode patterns is any one of polythiophene, polypyrrole, polyaniline, polyacetylene, and polypheylene polymers.

6. The method for manufacturing the capacitive touch screen as set forth in claim 1, wherein at the forming the first electrode pattern, the conductive polymer includes an alcohol solvent and the viscosity of the conductive polymer is 5 cps to 20 cps.

7. The method for manufacturing the capacitive touch screen as set forth in claim 1, wherein at the forming the first electrode pattern, the conductive polymer further includes silane-based compounds.

8. A method for manufacturing a capacitive touch screen, comprising:
forming a plurality of first electrode patterns made of conductive polymer on the upper surface of a first substrate by an inkjet method;
forming a plurality of second electrode patterns made of conductive polymer on the upper surface of a second substrate by the inkjet method; and
coupling the first substrate and the second substrate so that the first electrode patterns face the second electrode patterns, with an insulating layer therebetween.

9. The method for manufacturing the capacitive touch screen as set forth in claim 8, further comprising forming first electrode wirings made of metal and connected to the first electrode patterns at the edge regions of the first substrate, prior to the forming the first electrode patterns on the first substrate, and
forming second electrode wirings made of metal and connected to the second electrode patterns at the edge regions of the second substrate, prior to the forming the second electrode patterns on the second substrate.

10. The method for manufacturing the capacitive touch screen as set forth in claim 8, further comprising surface-reforming the first electrode pattern forming region on the upper surface of the first substrate, prior to forming the first electrode pattern, and
surface-reforming the second electrode pattern forming region on the upper surface of the second substrate, prior to the forming the second electrode pattern.

11. The method for manufacturing the capacitive touch screen as set forth in claim 8, wherein at the forming the first electrode pattern and forming the second electrode pattern, the conductive polymer forming the first electrode pattern and the second electrode pattern is any one of polythiophene, polypyrrole, polyaniline, polyacetylene, and polypheylene polymers.

12. The method for manufacturing the capacitive touch screen as set forth in claim 8, wherein at the forming the first electrode pattern and forming the second electrode pattern, the conductive polymer includes an alcohol solvent and the viscosity of the conductive polymer is 5 cps to 20 cps.

13. The method for manufacturing the capacitive touch screen as set forth in claim 8, wherein at the forming the first electrode patterns, the conductive polymer further includes silane-based compounds.
